(19) United States
(12) Patent Application Publication
(10) Pub. No.: US 2004/0054481 A1
(43) Pub. Date: Mar. 18, 2004

(54) Airspeed indicator with quantitative voice output

(76) Inventor: J. Timothy Lovett, Fayetteville, AR (US)

Correspondence Address: J TIMOTHY LOVETT, 387 BLUE SPRINGS ROAD, FAYETTEVILLE, AR, 72703, US

(21) Appl. No.: 10/245,642

(22) Filed: Sep. 18, 2002

(51) Int. Cl. G01L 7/00

(52) U.S. Cl. 702/50

(57) ABSTRACT

An airspeed indicator with quantitative voice output converts an electrical or pressure value to an indicated airspeed value and provides the numerical airspeed value to the pilot vocally. The device uses a precision pressure transducer to convert pitot tube pressure to an equivalent electrical signal, which is used to operate an indicator on the instrument panel and to operate a voice synthesizer to announce the current airspeed value to the pilot, either through a speaker in the aircraft cabin, in the pilot's headset or in the device itself. The vocal output from the airspeed indicator can be enabled or disabled, according to the pilot's needs. The frequency with which the device provides updated airspeed values to the pilot can be adjusted to suit the pilot's preference.

CROSS-REFERENCE TO RELATED APPLICATIONS: Not applicable.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISK APPENDIX

Not applicable.

### BACKGROUND OF THE INVENTION

This invention pertains to flight instrumentation, in particular an airspeed indicator, carried on-board an aircraft that provides quantitative flight information, namely the current airspeed of the aircraft, in real-time, to the pilot or pilots, by means of a recorded or synthesized voice, delivered via speakers in the cabin or the pilot(s) headset(s). Existing airspeed indicators provide real-time indication of an aircraft's airspeed by means of a gauge mounted on the instrument panel, which requires the pilot to frequently shift his or her visual focus from the external environment of the aircraft to the instrument panel in order to monitor the airspeed of the aircraft. Providing the pilot with real-time, quantitative airspeed values without the requirement to shift visual focus to the instrument panel will reduce pilot workload, improve pilot situational awareness and increase aircraft operational safety.

Instrumentation to measure the airspeed of an aircraft and to display that measured value in a visual format is well known in the art. The most common means of sensing the airspeed of an aircraft is by means of a pitot tube. The pitot tube was invented in 1732 by Henri Pitot and became a practical instrument for measurement of fluid flow velocity around 1856, when substantial improvements were implemented by Henry Darcy. The pitot tube utilizes the difference in pressure between two ports, one open to the flow direction and one at right angles to the flow direction, to deduce the fluid velocity. This device is used extensively as a speed indictor for aircraft, boats and in wind tunnels.

While the pitot tube is very rugged and performs well under steady flow conditions, it does not respond rapidly to changes in flow conditions or to changes in flow direction relative to the pitot tube. A number of improvements have been implemented to address these shortcomings. U.S. Pat. No. 5,299,455 addresses the use of heated wires exposed to the flowing air stream to measure airspeed and to visually display the measured value. U.S. Pat. No. 4,893,261 addresses the use of pressure variations occurring at the end of a rotor exposed to the air stream to deduce airspeed. U.S. Pat. No. 4,859,055 addresses the use of pairs of ribbon-shaped laser beams to measure the transit velocity and direction of atmospheric aerosol particles and thus to deduce airspeed. U.S. Pat. No. 4,319,333 addresses a means of converting a measured airspeed value to a mach number, which is visually displayed. It will be recognized that a considerable body of work has been done on alternative means of sensing and visually displaying airspeed values.

The potential value of utilizing the aural pathway for communicating information to the pilot of an aircraft is attested to by the considerable body of work that has been done on communicating warnings of the presence of emergency conditions. For example, U.S. Pat. Nos. 9,262,679 and 6,278,396 provide means of supplying pilots with display, tone and voice warnings of mid air and near mid air collision situations. U.S. Pat. Nos. 6,076,042 and 5,136,512 provide the pilot of an aircraft an audible warning of the hazard of collision of the aircraft with a stationary object or the ground. U.S. Pat. Nos. 4,590,475 and 6,169,496 provide audible warnings of an impending stall condition in level and in banked flight. U.S. Pat. Nos. 4,043,194 and 4,947,165 describe devices that provide a voice warning to a pilot of a dangerous wind shear condition. U.S. Pat. No. 5,519,391 describes a device that provides a pilot with voice warning of an improper flap position prior to take-off. U.S. Pat. No. 4,916,447 describes a device that provides a pilot with a voice warning of a landing gear-up condition during preparation for landing. U.S. Pat. No. 5,225,829 describes a means of alerting a pilot of a dangerously low airspeed condition, using a voice warning message. In all of these applications, the aural pathway is used either because the pilot has no indicator on the instrument panel that would alert him or her to the condition or because the pilot might not otherwise be aware of the emergency condition.

It is also know in the art that there is an inherent disadvantage associated with a requirement for a pilot of an aircraft to shift his or her visual focus away from the external environment of the aircraft in order to acquire information from flight instrumentation on the instrument panel. U.S. Pat. No. 6,057,786 provides a description of the use of a head-up display (HUD) to provide quantitative flight data in a visual format such that the pilot does not have to shift visual focus from outside to inside the aircraft.

The advantage of using the aural pathway for delivery of quantitative information has been demonstrated in the field of measuring electrical parameters using a voltmeter-ammeter-ohmmeter. U.S. Pat. No. 4,864,226 describes a meter for measuring electrical signals by placing measurement probes on points to be measured, with a visual display and a means of audibly announcing the measured value.

This invention takes advantage of the aural pathway to deliver to the pilot of an aircraft, not warnings of emergency conditions, but quantitative real-time, airspeed information. This will allow the pilot to make appropriate control responses without the need to shift visual focus from the aircraft external environment to the aircraft instrument panel.

### BRIEF SUMMARY OF THE INVENTION

This invention provides either an improved airspeed indicator with quantitative voice output or a means of modifying an existing airspeed indicator to provide a quantitative voice output. Means of measuring an aircraft's airspeed are well known, and typically use a pitot tube to sense stagnation pressure, which is proportional to and can be converted to, the aircraft's airspeed. Alternatively, the cooling effect of a moving air stream on the heated wire in a hot wire anemometer can be converted to an airspeed.

During certain flight operations, such as the take-off roll, climb out, and final approach to landing, the pilot must be aware of the aircraft's airspeed and take appropriate actions based upon that knowledge. Existing airspeed indicators, which provide a real-time, quantitative airspeed value by means of an indicating gauge on the instrument panel, require the pilot to shift his or her visual focus from outside the aircraft to the instrument panel, for as long as is required to interpret the value indicated by the gauge. This causes the pilot to lose his or her visual contact with the environment outside the aircraft. During the time period in which the pilot has lost visual contact with the environment outside the aircraft, conditions such as the aircraft attitude, or the presence or position of other aircraft or ground vehicles, may change. The pilot will be unable to respond to these changes in conditions until such time as visual contact is again regained and the changes identified. This invention provides a means of supplying the pilot with the needed airspeed information without requiring him or her to lose visual contact with the outside environment, by supplying real-time, quantitative, airspeed information via voice, delivered to the pilots hearing by speakers in the aircraft cabin or the pilots headset.

### DETAILED DESCRIPTION OF THE INVENTION

The purpose of this invention is to enhance aircraft operational safety and reduce pilot workload by supplying the pilot with important flight information, namely the aircraft's airspeed, via a recorded or synthesized voice, delivered in real-time, to the pilot by means of a speaker, either in the cabin, in the pilots headset, or mounted in the electronics housing of this invention.

During various flight operations, the pilot requires knowledge of the aircraft's airspeed to take certain control actions. During the take-off roll, for example, the pilot must monitor the aircraft's airspeed to determine when to rotate the aircraft's nose to initiate lift-off and begin the climb-out. This must only be done upon attaining sufficient flying speed for the particular aircraft. The pilot must also maintain the proper heading to keep the aircraft's line of travel down the runway centerline during the take-off roll. Maintaining the proper heading requires visual contact with the runway. Monitoring the aircraft's airspeed using conventional, existing, instrumentation, on the other hand, requires the visual focus to be shifted to the aircraft's instrument panel. This creates an unsafe situation in which conditions outside the aircraft may change during the period in which the pilot's focus is shifted to the instrument panel, and the pilot will not be able to respond to those changed conditions.

Similarly, during the final approach to landing, the pilot must maintain the proper approach speed, which requires knowledge of the aircraft's airspeed, and also maintain the proper heading for alignment with the runway. The pilot requires visual contact with the runway to maintain proper heading, while he or she requires visual contact with the panel mounted airspeed indicator to monitor proper airspeed. Again, this creates a situation in which the pilot must continually shift his or her visual focus between the outside environment and the instrument panel.

This invention provides a means of supplying the pilot with the needed real-time, quantitative, airspeed information without requiring the pilot to shift his or her visual focus from the aircraft's external environment. During the final approach, this will allow the pilot to make pitch corrections as necessary to maintain proper approach speed without ever shifting his or her visual focus from the runway and adjacent airspace.

During the take-off roll, this will allow the pilot to rotate the aircraft's nose to initiate lift-off and begin climb-out when the correct airspeed is reached, without ever having to shift his or her visual focus from the runway and adjacent taxiways and airspace. And during climb-out, this will allow the pilot to maintain best rate of climb speed or best angle of climb speed without losing visual contact with the aircraft's external environment.

The quantitative airspeed information will be supplied to the pilot vocally, which the pilot will hear either through the aircraft cabin speaker or the pilot's headset. The information will be supplied sufficiently frequently, perhaps once per second, to permit the pilot to maintain constant awareness of the aircraft's airspeed without breaking visual contact with the aircraft's external environment. The airspeed indicator with quantitative voice output will contain a means of activation, such that the user may elect to receive vocal updates of current airspeed value or not to. Also, it will contain a means to allow the user to adjust the frequency of the update.

A typical airspeed indicator uses a pitot tube, which senses the stagnation pressure associated with the air density and the speed of the air entering the pitot tube. The gauge mechanism mechanically converts the stagnation pressure to movement of a needle on the face of the gauge, which indicates the speed of the air entering the pitot tube. This invention provides both 1.) a stand alone airspeed indicator with a voice output, suitable for installation in a new or existing aircraft, and 2.) a means of converting a standard pitot tube airspeed indicator to a voice output airspeed indicator. The two approaches share most components.

In a preferred embodiment of the improved airspeed indicator with voice output, a standard pitot tube is used to provide a differential pressure signal to both the analog instrument on the instrument panel, which may be an existing or a newly installed instrument, and to the voice output circuit. The pitot tube is a well known method of measuring the speed of a fluid stream or a vehicle through a fluid stream. The differential pressure signal from the pitot tube is supplied to a differential pressure transducer, as is know in the art, which converts the time varying pneumatic signal to a time varying electrical signal. The electrical signal is supplied to an analog to digital converter, which samples the analog electrical signal at predetermined intervals and converts the analog value of the electrical signal to a digital value. The output from the analog to digital converter is supplied to the microprocessor. The microprocessor operates on the raw digital value of pressure differential to produce a computed value of airspeed. (Some microprocessors have built-in analog to digital converters, in which case the external analog to digital converter would be unnecessary.) The raw value of pressure differential is converted to computed airspeed by reference to a calibration equation. If the differential pressure transducer is linear, the calibration equation can take the form of:

Computed airspeed=(pressure differential)×(scale factor)+static offset (eq. 1)

The values of the scale factor and the static offset are determined during the performance of a calibration procedure and are stored in data registers in the microprocessor. The computed airspeed digital value from the microprocessor is supplied to a voice synthesis or voice recording module. The differential pressure transducer, the analog to digital converter, the microprocessor and the voice synthesizer or voice recorder are all supplied with electrical power from a power supply, which may be a common storage battery. For convenience, all of the above components (except the pitot tube and instrument panel analog display) may be housed together, in a single package. The voice synthesis or recording module converts the digital value of computed airspeed to an audio electrical signal that is supplied to the pilots headset, which converts the audio electrical signal to a synthesized or recorded voice, which provides the quantitative airspeed information to the pilot.

It should be recognized that there are some obvious variations on the preferred embodiment. For example, the pitot tube may be replaced by an airspeed indicating device that produces an electrical output, such as a hot wire anemometer airspeed indicator, as is know in the art. Since this type of airspeed indicating device already produces an electrical output, no differential pressure transducer would be required, and the electrical signal would be supplied to the analog to digital converter. The output from the analog to digital converter is then supplied to a microprocessor. If a microprocessor with the capability to receive analog inputs were used, no analog to digital converter would be required. The microprocessor operates on the raw airspeed value to convert it to a computed airspeed value, as before, using the stored values for scale factor and static offset. The computed airspeed digital value is then supplied to the voice synthesizer or recording module, which converts it to an audio electrical signal. Again, all of these components except the portion of the airspeed indicator mounted in the air stream and the indicating gauge on the instrument panel may be located in common housing. As an alternative to the common storage battery of the previous description, the power for these components may be supplied from the aircraft's electrical system. The output from the voice synthesizer or recording module may be supplied to the aircraft's cabin speaker, rather than the pilots headset. Another alternative to supplying the audio electrical signal to either the cabin speaker or the pilot's headset would be to supply it to a self-contained speaker, mounted in the common housing of this invention.

### BRIEF DESCRIPTION OF THE SEVERAL VIEWS OF THE DRAWINGS

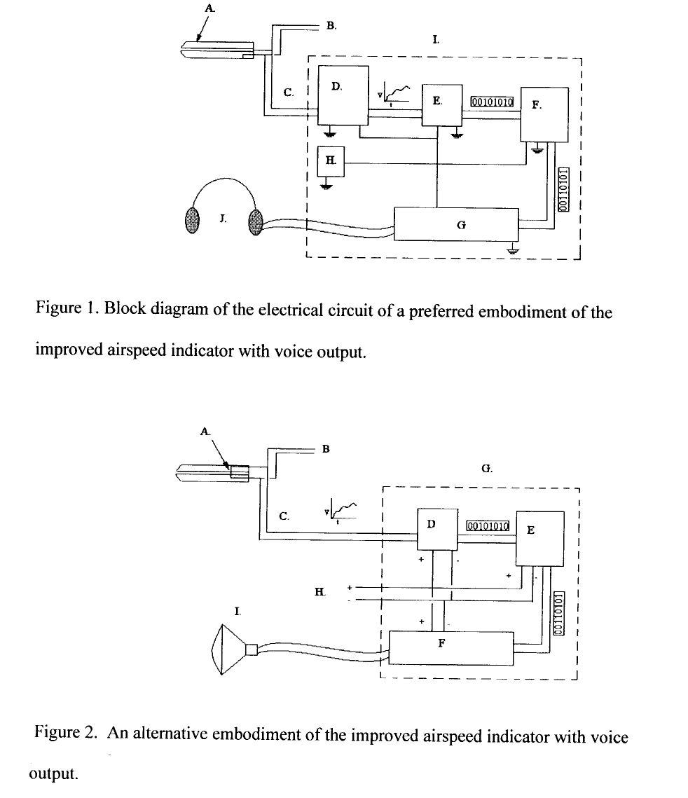

A block diagram of the electrical circuit of a preferred embodiment of the improved airspeed indicator with voice output is shown in FIG. 1. A standard pitot tube (A.) is used to provide a differential pressure signal to both the analog instrument on the instrument panel (B.) and to the voice output circuit (C.). The differential pressure signal from the pitot tube is supplied to a differential pressure transducer (D.), as is know in the art, which converts the time varying pneumatic signal to a time varying electrical signal. The electrical signal is supplied to an analog to digital converter (E.), which samples the analog electrical signal at predetermined intervals and converts the analog value of the electrical signal to a digital value. The output from the analog to digital converter is supplied to the microprocessor (F.). The microprocessor operates on the raw digital value of pressure differential to produce a computed value of airspeed. Some microprocessors have built-in analog to digital converters, in which case the external analog to digital converter (E.) would be unnecessary. The raw value of pressure differential is converted to computed airspeed by reference to a calibration equation, containing a scale factor and an offset value. The values of the scale factor and the static offset are determined during the performance of a calibration procedure and are stored in data registers in the microprocessor (F.). The computed airspeed digital value from the microprocessor is supplied to the voice synthesis or voice recording module (G.). Components D, E, F and G are supplied with electrical power from a power supply (H.), which may be a common storage battery. For convenience, components D, E, F, G and H may be housed together, in a single package (I.). The voice synthesis or recording module (G.) converts the digital value of computed airspeed to an audio electrical signal that is supplied to the pilots headset (J.), which converts the audio electrical signal to a synthesized or recorded voice, which provides the quantitative airspeed information to the pilot.

It should be recognized that there are some obvious variations on the preferred embodiment. One such variation is shown in FIG. 2. The pitot tube of FIG. 1 has been replaced by an airspeed indicating device that produces an electrical output, such as a hot wire anemometer, as is know in the art. Since the airspeed indicating device already produces an electrical output, no differential pressure transducer is required, and the electrical signal can be supplied to the analog to digital converter (D.). The output from the analog to digital converter (D.) is supplied to a microprocessor (E.). If a microprocessor with the capability to receive analog inputs is used, no analog to digital converter would be required. The microprocessor operates on the raw airspeed value to convert it to a computed airspeed value, as before, using the stored values for scale factor and static offset. The computed airspeed digital value is supplied to the voice synthesizer or recording module (F.), which converts it to an audio electrical signal. Again, components D., E. and F. may be located in common housing (G.) As an alternative to the common storage battery of FIG. 1, the power for components D., E. and F. may be supplied from the aircraft's electrical system (H.). The output from the voice synthesizer or recording module may be supplied to the aircraft's cabin speaker (I.), rather than the pilots headset. An alternative is to provide speaker (I.) as part of the device and mount it in the common housing (G.)

I claim:

1. An airspeed indicator that provides a real-time, quantitative voice output to the pilot(s) of an aircraft, or

2. A means of modifying an existing airspeed indicator to provide a real-time, quantitative voice output to the pilot(s) of an aircraft,

3. The device according to claims 1 and 2 above, in which a differential pressure signal from a pitot tube is converted to an electrical signal, which is in turn converted to a voice output and supplied to the pilot(s) by means of speakers in the pilot(s) headset(s), in the aircraft cabin or mounted in the electronics housing of the device itself.

4. The device according to claims 1 and 2 above, in which an electrical signal from an airspeed indicating device is converted to a voice output and supplied to the pilot(s) by means of speakers in the pilot(s) headset(s), in the aircraft cabin or mounted in the electronics housing of the device itself.

5. The device according to claims 1 and 2 above, in which the electronic components are powered by a storage battery.

6. The device according to claims 1 and 2 above, in which the electronic components are powered from the aircraft electrical system.

7. The device according to claims 1 and 2 above, in which the speaker for delivering the vocal output to the pilot(s) is contained in the housing for the electronic components.

8. The device according to claims 1 and 2 above, in which a switch is included to activate the airspeed vocal output function, to permit the user to elect when to activate the function.

9. The device according to claims 1 and 2 above, in which the rate at which the device provides updated airspeed values can be adjusted.

10. The device according to claims 1 and 2 above, in which updated airspeed values can be supplied based upon criteria other than elapsed time, such as the magnitude of the change in value since the last value provided.

11. The device according to claims 1 and 2 above, in which updated airspeed values can be supplied based upon combinations of criteria, such as elapsed time and magnitude of change in airspeed value since last update.
